(19) United States
(12) Patent Application Publication
(10) Pub. No.: US 2024/0028903 A1
(43) Pub. Date: Jan. 25, 2024

(54) SYSTEM AND METHOD FOR CONTROLLING MACHINE LEARNING-BASED VEHICLES

(71) Applicant: RENAULT S.A.S, Boulogne Billancourt (FR)

(72) Inventors: Andrea ANCORA, Valbonne (FR); Sebastien AUBERT, Valbonne (FR); Vincent REZARD, Valbonne (FR); Philippe WEINGERTNER, Valbonne (FR)

(73) Assignee: RENAULT S.A.S, Boulogne Billancourt (FR)

(21) Appl. No.: 18/255,474

(22) PCT Filed: Dec. 3, 2021
(86) PCT No.: PCT/EP2021/084275

§ 371 Date: Jun. 1, 2023

(30) Foreign Application Priority Data
Dec. 4, 2020 (FR) FR2012721

(51) Int. Cl. G06N 3/084

(52) U.S. Cl. CPC G06N 3/084

(57) ABSTRACT

A control device is used in a vehicle including a perception system which uses sensors. The perception system includes a device for estimating a variable including a characteristic relating to objects detected in the surrounding area of the vehicle, the estimation device including an online learning module which uses a neural network to estimate the variable. The learning module includes: a forward-propagation module to propagate data from sensors, which data are applied as the input to the neural network, so as to provide a predicted output including an estimate of the variable; a fusion system to determine a fusion output by implementing a sensor fusion algorithm using the predicted values; a back-propagation module to update weights associated with the online neural network by determining a loss function representing the error between an improved predicted value of the fusion output and the predicted output by performing gradient descent back propagation.

### TECHNICAL FIELD

The invention relates in general to control systems, and in particular to vehicle control systems and methods.

Automated or semi-automated vehicles generally have embedded control systems such as driving assistance systems for controlling vehicle driving and safety, such as for example an ACC (“Adaptive Cruise Control”) distance regulation system used to regulate distance between vehicles.

Such driving assistance systems conventionally use a perception system comprising a set of sensors (for example cameras, lidars or radars) arranged on the vehicle to detect environmental information that is used by the control device to control the vehicle.

The perception system comprises a set of perception modules associated with the sensors to detect objects and/or predict the position of objects in the environment of the vehicle using the information provided by the sensors.

Each sensor provides information associated with each detected object. This information is then delivered at the output of the perception modules to a fusion system.

The sensor fusion system processes the object information delivered by the perception modules in order to determine an improved and consolidated view of the detected objects.

In existing solutions, learning systems are used by the perception system to predict the position of an object (such as for example the SSD, YOLO, SqueezeDet systems). Such a prediction is made by implementing an offline learning phase, using a history of data determined or measured in previous time windows. With the learning being ‘offline’, the data collected in real time by the perception system and the fusion modules are not used for learning, the learning being performed in phases in which the driving assistance device is not operational.

To carry out this offline learning phase, a database of learning images and a set of tables comprising ground truth information are conventionally used. A machine learning algorithm is implemented in order to initialize the weights of the neural network from an image database. In existing solutions, this phase of initializing weights is implemented “offline”, that is to say outside of the phases of use of the vehicle control system.

The neural network with the weights fixed in this way may then be used in what is called a generalization phase that is implemented online to estimate features of objects in the environment of the vehicle, for example detect objects in the environment of the vehicle or predict trajectories of objects detected during online operation of the driving assistance system.

Thus, in existing solutions, the learning phase that makes it possible to set the weights of the neural network is performed offline, the estimation of the object features then being carried out online (that is to say during operation of the vehicle control system) based on these fixed weights.

However, such learning does not make it possible to take into account new images collected in real time during operation of the vehicle, and is limited to the learning data stored in the static database. With the detected objects being, by definition, not known a priori, it is impossible to update the parameters of the model (weights of the neural network) in real time. The new predictions that are made are thus carried out without updating the model parameters (weights of the neural network), and may therefore be unreliable.

Various learning solutions have been proposed in the context of driving assistance.

For example, U.S. Pat. No. 10,254,759 B1 proposes a method and a system using offline enhanced learning techniques. Such learning techniques are used to train a virtual interactive agent. They are based on extracting observation information for learning in a simulation system not suitable for a driving assistance system in a vehicle. In particular, such an approach does not make it possible to provide an online, embedded solution that makes it possible to continuously improve the prediction based on the data provided by the fusion system. Moreover, this approach is not suitable for object trajectory prediction or object detection in a vehicle.

US 2018/0124423 A1 describes a trajectory prediction method and system for determining prediction samples for agents in a scene based on a past trajectory. Prediction samples are associated with a score based on a probability score that incorporates interactions between agents and a semantic scene context. The prediction samples are iteratively refined using a regression function that accumulates the scene context and agent interactions across the iterations. However, such an approach is also not suitable for trajectory prediction and object detection in a vehicle.

US 2019/0184561 A1 has proposed a solution based on neural networks. This solution uses an encoder and a decoder. However, it uses an input highly specific to lidar data and to offline learning. Moreover, such a solution relates to decision-making or planning assistance techniques and is also not suitable for trajectory prediction or object detection in a vehicle.

The existing solutions thus do not make it possible to improve the estimation of the features of objects detected in the environment of the vehicle based on machine learning.

There is thus a need for a machine learning-based vehicle control device and method that are capable of providing an improved estimation of the features in relation to objects detected in the environment of the vehicle.

### General Definition of the Invention

The invention aims to improve the situation by proposing a control device implemented in a vehicle, the vehicle comprising a perception system using a set of sensors, each sensor providing data, the perception system comprising an estimation device for estimating a variable comprising at least one feature in relation to one or more objects detected in the environment of the vehicle, the estimation device comprising the online learning module using a neural network to estimate the variable, the neural network being associated with a set of weights. Advantageously, the learning module may comprise:
a forward propagation module configured to propagate data from one or more sensors applied at input of the neural network, so as to provide a predicted output comprising an estimation of the variable;
a fusion system configured to determine a fusion output by implementing at least one sensor fusion algorithm based on at least some of the predicted values,
a backpropagation module configured to update the weights associated with the neural network online by determining a loss function representing the error between an improved predicted value of the fusion output and the predicted output and by performing a gradient descent backpropagation.

In one embodiment, the variable may be a state vector comprising information in relation to the position and/or the movement of an object detected by the perception system.

Advantageously, the state vector may furthermore comprise information in relation to one or more detected objects.

The state vector may furthermore comprise trajectory parameters of a target object.

In one embodiment, the improved predicted value may be determined by applying a Kalman filter.

In one embodiment, the device may comprise a replay buffer configured to store the outputs predicted by the estimation device and/or the fusion outputs delivered by the fusion system.

In some embodiments, the device may comprise a recurrent neural network encoder configured to encode and compress the data prior to storage in the replay buffer, and a decoder configured to decode and decompress the data extracted from the replay buffer.

In particular, the encoder may be a recurrent neural network encoder and the decoder may be a corresponding recurrent neural network decoder.

In some embodiments, the replay buffer may be prioritized.

The device may implement a condition for testing input data applied at input of a neural network, input data being deleted from the replay buffer if the loss function between the value predicted for this input sample and the fusion output may be lower than a predefined threshold.

Also proposed is a control method implemented in a vehicle, the vehicle comprising a perception system using a set of sensors, each sensor providing data, the control method comprising estimating a variable comprising at least one feature in relation to one or more objects detected in the environment of the vehicle, the estimation implementing an online learning step using a neural network to estimate the variable, the neural network being associated with a set of weights. Advantageously, the online learning step may comprise the steps of:
propagating data from one or more sensors applied at input of the neural network, thereby providing a predicted output comprising an estimation of the variable;
determining a fusion output by implementing at least one sensor fusion algorithm based on at least some of the predicted values,
updating the weights associated with the neural network online by determining a loss function representing the error between an improved predicted value of the fusion output and the predicted output by performing a gradient descent backpropagation.

### BRIEF DESCRIPTION OF THE DRAWINGS

Other features, details and advantages of the invention will become apparent on reading the description given with reference to the appended drawings, which are given by way of example and in which, respectively:

FIG. 1 is a diagram showing a driving assistance system using machine learning to estimate features of detected objects, according to some embodiments of the invention;

FIG. 2 is a diagram showing an estimation device, according to some embodiments of the invention;

FIG. 3 is a simplified diagram showing the driving assistance system 10, according to one exemplary embodiment;

FIG. 4 is a flowchart showing the neural network online learning method, according to some embodiments;

FIG. 5 is a flowchart showing the learning method according to one exemplary embodiment, in one application of the invention to trajectory prediction;

FIG. 6 shows one exemplary implementation of the control system in which the perception system uses a single smart camera sensor for an object trajectory prediction application; and

FIG. 7 shows another exemplary embodiment of the control system using encoding/decoding of the data predicted by the neural network.

### DETAILED DESCRIPTION

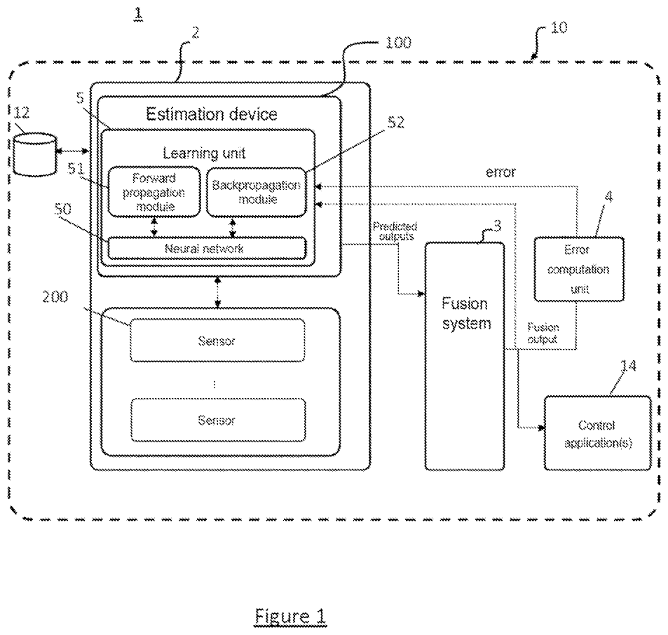

FIG. 1 shows a control system 10 embedded in a mobile apparatus 1, such as a vehicle. The rest of the description will be given with reference to a mobile apparatus that is a vehicle, by way of non-limiting example.

The control system 10 (also called ‘driving assistance system’ below) is configured to assist the driver in performing complex driving operations or maneuvers, detect and avoid hazardous situations, and/or limit the impact of such situations on the vehicle 1.

The control system 10 comprises a perception system 2 and a fusion system 3 that are embedded in the vehicle.

The control system 10 may furthermore comprise a planning and decision-making assistance unit and one or more controllers (not shown).

The perception system 2 comprises one or more sensors 20 arranged in the vehicle 1 to measure variables in relation to the vehicle and/or the environment of the vehicle. The control system 10 uses the information provided by the perception system 2 of the vehicle 1 to control the operation of the vehicle 1.

The driving assistance system 10 comprises an estimation device 100 configured to estimate a variable in relation to one or more object features representing features of one or more objects detected in the environment of the vehicle 1 by using the information provided by the perception system 2 of the vehicle 1 and by implementing an online machine learning ML algorithm using a neural network 50.

Initially, learning is implemented in order to learn the weights of the neural network, from a learning database 12 storing observed past (ground truth) values observed for the variable in correspondence with data captured by the sensors.

Advantageously, online learning is furthermore implemented during operation of the vehicle in order to update the weights of the neural network using the output delivered by the fusion system 3, determined based on the output predicted by the perception system 2 and determining the error between an improved predicted value derived from the output from the fusion system 3 and the predicted output delivered by the perception system 2.

The weights of the neural network 50 form the parameters of the neural or perception model represented by the neural network.

The learning database 12 may comprise images of objects (cars for example) and of roads, and, in association with each image, the expected value of the variable in relation to the object features corresponding to the ground truth.

The estimation device 100 is configured to estimate (or predict), in what is called a generalization phase, the object feature variable for an image captured by a sensor 200 by using the neural network with the latest model parameters (weights) updated online. Advantageously, the predicted variable is itself used to update the weights of the neural network 50 based on the error between the variable predicted by the perception system 2 and the value of the variable obtained after fusion by the fusion system 3.

Such learning, carried out online during operation of the driving assistance system 10, makes it possible to update the parameters of the model, represented by the weights of the neural network 50, dynamically or quasi-dynamically rather than using fixed weights that are determined “offline” beforehand in accordance with the approach from the prior art.

In some embodiments, the variable estimated by the estimation device 100 may comprise position information in relation to an object detected in the environment of a vehicle, such as another vehicle, in an application to object detection, or target object trajectory data, in an application to target object trajectory prediction.

The control system 10 may be configured to implement one or more control applications 14, such as a cruise control application ACC able to regulate the distance between vehicles, configured to implement a control method in relation to controlling the driving or safety of the vehicle based on the information delivered by the fusion system 3.

The sensors 200 of the perception system 2 may include various types of sensors, such as, for example and without limitation, one or more lidar (Laser Detection And Ranging) sensors, one or more radars, one or more cameras, which may be cameras operating in the visible and/or cameras operating in the infrared, one or more ultrasonic sensors, one or more steering wheel angle sensors, one or more wheel speed sensors, one or more brake pressure sensors, one or more yaw rate and transverse acceleration sensors, etc.

The objects in the environment of the vehicle 1 that are able to be detected by the estimation device 100 comprise moving objects, such as for example vehicles traveling in the environment of the vehicle.

In the embodiments in which the perception system 2 uses sensors to detect objects in the environment of the vehicle 1 (lidar and/or radar for example), the object feature variable estimated by the estimation device may be for example a state vector comprising a set of object parameters for each object detected by the radar, such as for example:
The type of object detected;
A position associated with the detected object; and
An uncertainty measure represented by a covariance matrix.

The fusion system 3 is configured to apply one or more processing algorithms (fusion algorithms) to the variables predicted by the perception system 2 based on the information from various sensors 200 and to provide a fusion output corresponding to a consolidated predicted variable for each detected object determined based on the variables predicted for the object based on the information from various sensors. For example, for position information of a detected object, predicted by the estimation device 100 based on the sensor information 200, the fusion system 3 provides more precise position information corresponding to an improved view of the detected object.

The perception system 2 may be associated with perception parameters that may be defined offline by calibrating the performance of the perception system 2 on the basis of the embedded sensors 200.

Advantageously, the control system 10 may be configured to:
use the past and/or future output data from the fusion unit 3 (fusion data), with respect to a current time;
process such past and/or future fusion data to determine a more precise estimation of the output from the fusion unit 3 at a current time (thereby providing an improved output from the fusion system);
use such an improved output from the fusion system 3 as a replacement for the ground truth data, stored in the learning database 12, to perform supervised “online” learning of the perception models and improve the estimation of the object feature variable (used for example to detect objects in the environment of the vehicle and/or to predict trajectories of target objects).

The online learning may thus be based on a delayed output from the estimation device 100.

The embodiments of the invention thus advantageously use the output from the fusion system 3 to update the weights of the neural networks online.

In particular, the estimation device 100 may comprise a neural network 50-based ML learning unit 5 implementing:
an initial learning (or training) phase for training the neural network 50 from the image database 12,
a generalization phase for estimating (or predicting) the detected object feature variable (for example detected object positions or object trajectory prediction) based on the current weights,
online learning for updating the weights of the neural network 50 based on the output from the fusion system (determined based on the predicted variable in phase B), the weights updated in this way being used for new estimations in the generalization phase.

The ML (machine learning) learning algorithm makes it possible for example to take input images from one or more sensors and to return an estimated variable (output predicted by the perception system 2) comprising the number of objects detected (cars for example) and the positions of the objects detected in the generalization phase. The estimation of this estimated variable (output predicted by the perception system 2) is improved by the fusion system 3, which provides a fusion output corresponding to the consolidated predicted variable.

A neural network is a computational model that imitates the operation of biological neural networks. A neural network comprises neurons interconnected by synapses that are generally implemented in the form of digital memories (resistive components for example). A neural network 50 may comprise a plurality of successive layers, including an input layer carrying the input signal and an output layer carrying the result of the prediction made by the neural network and one or more intermediate layers. Each layer of a neural network takes its inputs from the outputs of the previous layer.

The signals propagated at the input and at the output of the layers of a neural network 50 may be digital values (information coded in the value of the signals), or electrical pulses in the case of pulse coding.

Each connection (also called a “synapse”) between the neurons of the neural network 50 has a weight θ (parameter of the neural model).

The training (learning) phase of the neural network 50 consists in determining the weights of the neural network for use in the generalization phase.

An ML (machine learning) algorithm is applied in the learning phase to optimize these weights.

By training the model represented by the neural network online with numerous data including the outputs from the fusion system 3, the neural network 50 is able to learn more precisely the significance that one weight had relative to another.

In the initial learning phase (which may take place offline), the neural network 50 first initializes the weights randomly and adjusts the weights by checking whether the error between the output obtained from the neural network 50 (predicted output) with an input sample drawn from the training base and the target output from the neural network (expected output), computed using a loss function, decreases using a gradient descent algorithm. Numerous iterations of this phase may be implemented, in which the weights are updated in each iteration, until the error reaches a certain value.

In the online learning phase, the neural network 50 adjusts the weights based on the error between:
the output delivered by the neural network 50 (predicted output) obtained in response to images provided by the sensors 200, and
a value derived from the consolidated fusion output based on such outputs predicted by the estimation device (improved predicted output).

The error between the prediction of the perception system and the fusion output is represented by a loss function L, using a gradient descent algorithm. Numerous iterations of this phase may be implemented, in which the weights are updated in each iteration, until the error reaches a certain value.

The learning unit 5 may comprise a forward propagation module 51 configured to apply, in each iteration of the online learning phase, the inputs (samples) to the neural network 50, which will produce an output, called predicted output, in response to such an input.

The learning unit 5 may furthermore comprise a backpropagation module 52 for backpropagating the error in order to determine the weights of the neural network by applying a gradient descent backpropagation algorithm.

The ML learning unit 5 is advantageously configured to backpropagate the error between the improved predicted output derived from the fusion output and the predicted output delivered by the perception system 2 and update the weights of the neural network “online”.

The learning unit 5 thus makes it possible to train the neural network 50 for a prediction “online” (in real time or non-real time) dynamically or quasi-dynamically, and thus to obtain a more reliable prediction.

In the embodiments in which the estimation device 100 is configured to determine features of objects detected by the perception system 2 (for example by a radar), the estimation device 100 may provide for example a predicted output representing an object state vector comprising a set of predicted position information (perception output). The perception system 2 may transmit, to the fusion system 3, the object state vectors corresponding to the various detected objects (perception object state vectors), as determined by the estimation device 100. The fusion system 3 may apply fusion algorithms to determine a consolidated object state vector (fusion output) for each detected object that is more precise than the perception output based on the state vectors determined by the perception system 2 for the detected objects. Advantageously, the consolidated object state vectors (also called “improved object state vectors” below), determined by the fusion system 3 for the various objects, may be used by the backpropagation module 52 of the online learning unit 5 to update the weights on the basis of the error between:
the improved predicted output derived from the output from the fusion system 3 (improved object state vectors), and
the output from the perception system 2 (perception object state vectors).

The driving assistance system 10 may comprise an error computation unit 4 for computing the error between the improved predicted output derived from the fusion system 3 (improved object state vectors) and the output from the perception system 2 (perception object state vectors).

The error thus computed is represented by a loss function. This loss function is then used to update the parameters of the perception models. The parameters of a perception model, also called a “neural model”, correspond to the weights θ of the neural network 50 used by the estimation device 100.

The backpropagation algorithm may advantageously be a stochastic gradient descent algorithm based on the gradient of the loss function (the gradient of the loss function will hereinafter be denoted (∇L(y⁽ⁱ⁾, ŷ⁽ⁱ⁾)).

The backpropagation module 52 may be configured to compute the partial derivatives of the loss function (error metric determined by the error computation unit 4) with respect to the parameters of the machine learning model (weights of the neural networks) by implementing the gradient descent backpropagation algorithm.

The weights of the neural networks may thus be updated (adjusted) upon each update provided at the output of the fusion system 3 and therefore upon each update of the error metric computed by the error computation unit 4.

Such an interface between the fusion system 3 and the perception system 2 advantageously makes it possible to implement “online” backpropagation.

The weights may be updated locally or remotely using for example V2X communication when the vehicle 1 is equipped with V2X communication means (autonomous vehicle for example).

The weights updated in this way correspond to a slight modification of the weights that had been used for the object detection or the object trajectory prediction that was used to generate the error metric used for online learning. They may then be used for a new object detection or trajectory prediction performed by the sensors, which in turn provides new information in relation to the detected objects that will be used iteratively to update the weights online again, in a feedback loop.

Such iterative online updates of the weights of the perception or prediction model make it possible to incrementally and continuously improve the perception or prediction models.

The estimations of the object state vectors may thus be used to determine an error measure suitable for online learning via error backpropagation.

The embodiments of the invention thus allow a more precise prediction of detected object features (object detection and/or object trajectory prediction for example), which may be used in parallel, even if the prediction is delayed.

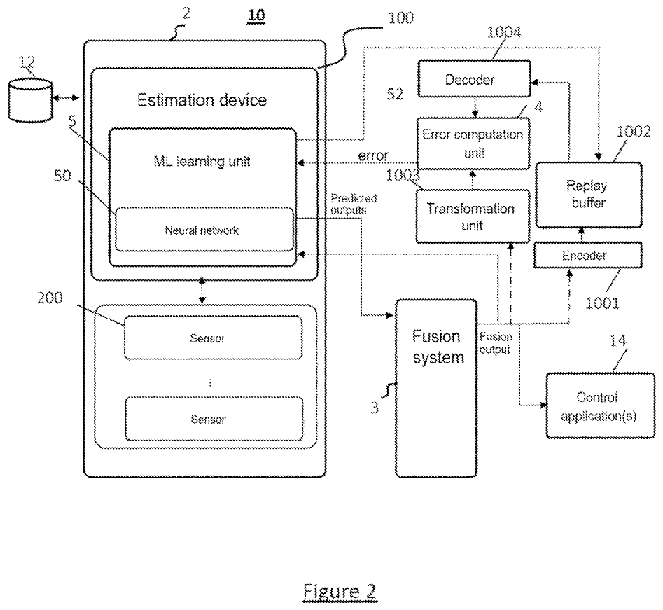

FIG. 2 is a diagram showing an estimation device 100, according to some embodiments.

In such an embodiment, the estimation device 100 may comprise an encoder 1001 configured to encode and compress the object information returned by the fusion system 3 and/or the perception system 2 for use by the learning unit 5. In one embodiment, the encoder 1001 may be an encoder for a Recurrent Neural Network (RNN), for example an LSTM (acronym for “Long Short-Term Memory”) RNN. Such an embodiment is particularly suitable for cases in which the object information requires a large memory, such as for example the object trajectory information used for object trajectory prediction. The rest of the description will be given mainly with reference to an RNN encoder 1001, by way of non-limiting example.

The estimation device 100 may furthermore comprise an experience replay buffer 1002 configured to store the compressed object data (object trajectory data for example).

In one embodiment, the estimation device 100 may comprise a transformation unit 1003 configured to transform data that are not “independent and identically distributed” data into “independent and identically distributed” (“iid”) data using filtering or delayed sampling of the data from the replay buffer 1002.

Indeed, in some embodiments, when the estimation method implemented by the estimation device 100 is for example based on a trajectory prediction algorithm, the data used by the estimation device are preferably independent and identically distributed (“iid”) data.

Indeed, samples that are strongly correlated may distort the assumption that the data are independent and identically distributed (iid), which needs to be satisfied for the gradient estimation performed by the gradient descent algorithm.

The replay buffer 1002 may be used to collect data sequentially as they arrive, by erasing the data stored previously in the buffer 1002, thereby making it possible to enhance learning.

To update the weights during online learning, a batch of data may be sampled randomly from the replay buffer 1002 and used to update the weights of the neural model. Some samples may have more influence than others on the updating of the weight parameters. For example, a larger gradient of the loss function ∇L(y⁽ⁱ⁾, ŷ⁽ⁱ⁾) may lead to larger updates of the weights θ. In one embodiment, storage in the buffer 1002 may furthermore be prioritized and/or prioritized buffer replay may be implemented.

In such an embodiment, the estimation device 100 thus makes it possible to perform online and incremental machine learning in order to train the neural networks using object data (trajectory data for example) that are compressed and encoded and then stored in the buffer 1002.

A decoder 1004 may be used to decode the data extracted from the replay buffer 1002. The decoder 1004 is configured to perform an operation inverse to that implemented by the encoder 1001. Thus, in the embodiment in which an RNN encoder 1001 is used, an RNN decoder 1004 is also used.

The embodiments of the invention advantageously provide a feedback loop between the output from the fusion system 3 and the perception system 2.

The embodiments of the invention thus make it possible to consolidate the information associated with each object detected by a plurality of sensors 200 such that the precision of the information is improved at the output from the fusion system 3 compared to the information provided by each perception unit 20 associated with an individual sensor 200. The error between the output from the perception system 2 and the output from the fusion system 3 is computed and is used to guide “online” learning and updating of the weights of the perception model (weights of the neural network 50). The error is then backpropagated to the neural network model 50 and partial derivatives of the error function (also called “cost function”) for each parameter (that is to say weight) of the neural network model are computed.

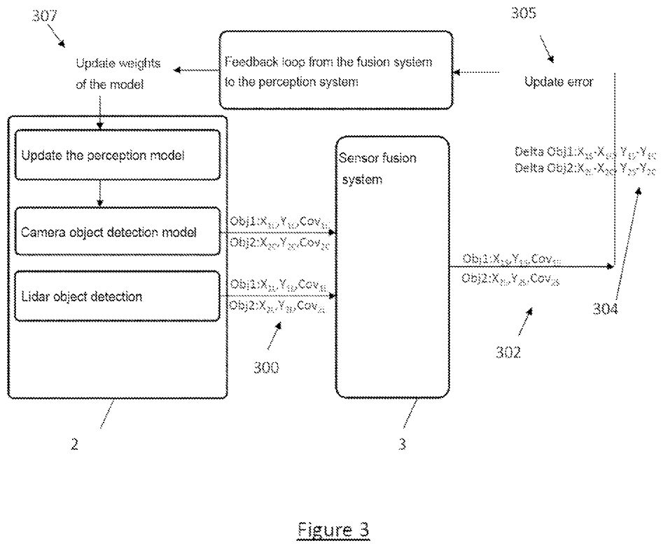

FIG. 3 is a simplified diagram showing the operation of the driving assistance system 10, according to one exemplary embodiment.

In the example of FIG. 3, consideration is given to a pipeline of two sensors 200, by way of non-limiting example. It is furthermore assumed that a convolutional neural network CNN-based model is used for the object detection performed by a camera sensor 200 and a lidar sensor 200. It should however be noted that the invention may more generally be applied to any neural network model capable of performing online learning in a pipeline in which a perception system 2 is followed by a fusion system 3.

Considering, more generally, a pipeline of M sensors, assuming that each sensor 200-i from among the M sensors detects P objects, the variable estimated by the estimation device 100 for each sensor and each k-th object detected by a sensor 200-i may be represented by a state vector comprising:
The position (xₖᵢ, yₖᵢ) of the object Objₖ in a Cartesian coordinate system having a chosen abscissa axis x and ordinate axis y:
A covariance matrix Covₖᵢ associated with the object Obⱼₖ that captures a measure of uncertainty of the predictions made by the sensor 200-i.

In the example of FIG. 3, consideration is given for example to two sensors 200-1 and 200-2, the first sensor 200-1 being the camera and the second sensor 200-2 being the lidar, each sensor each detecting two identical objects Obj₁ and Obj₂.

The variable predicted based on the data captured by the first camera (“C”) sensor 200-1 may then comprise:
the following state vector for the object Obj₁: {x_{1C}, y_{1C}, Cov_{1C}} comprising the position data x_{1C}, y_{1C} of the first object Obj1 and the covariance matrix Cov_{1C};
the following state vector for the object Obj₂: {x_{2L}, y_{2L}, Cov_{2L}} comprising the position data x_{2L}, y_{2L} of the second object Obj₂ and the covariance matrix Cov_{2L}.

The variable predicted based on the data captured by the second lidar (“L”) sensor 200-2 may comprise:
the following state vector for the object Obj1: {x_{1S}, y_{1S}, Cov_{1S}} comprising the position data x_{1S}, y_{1S} of the first object Obj1 and the covariance matrix Cov_{1S} associated with the first object and with the sensor 200-1;
the following state vector for the object Obj2: {x_{2L}, y_{2L}, Cov_{2L}} comprising the position data x_{2L}, y_{2L} of the second object Obj2 and the covariance matrix Cov_{2L} associated with the second object and with the sensor 200-2.

The information in relation to the detected objects as provided by the perception system may then be consolidated (by fusing said information) by the fusion system 3, which determines, based on the consolidated sensor information, a consolidated predicted variable (fusion output) comprising, for each detected object Objk, the state vector (x_{kS}, y_{kS}, CovkS), comprising the consolidated position data (x_{kS}, y_{kS}) for the first object Obj1 and the consolidated covariance matrix Cov_{kS} associated with the first object.

The coordinates (x_{kS}, y_{kS}) are determined based on the information (xik, yik) provided for each object k and each sensor 200-i. The covariance matrix Cov_{kS} is determined based on the information Covₖᵢ provided for each object k and each sensor i.

In the example under consideration of two sensors comprising a camera sensor and a lidar sensor, the two sensors detecting two objects, the information in relation to the detected objects as consolidated by the fusion unit 2 comprises:
the following state vector for the object Obj1: {x_{1S}, y_{1S}, Cov_{1S}} comprising the consolidated position data for the first object Obj1 based on the information x_{1C}, y_{1C}, x_{1L}, y_{1L} and the consolidated covariance matrix associated with the first object based on Cov_{1C} and Cov_{1L},
the following state vector for the object Obj2: {x_{2S}, y_{2S}, Cov_{2S}} comprising the consolidated position data for the second object Obj2 based on the information x_{2C}, y_{2C}, x_{2L}, y_{2L} and the consolidated covariance matrix associated with the second object based on Cov_{2C} and Cov_{2L}.

The positioning information x_{kS}, y_{kS} provided by the fusion unit 2 for each k-th object has an associated uncertainty less than or equal to that associated with the positioning information provided individually by the sensors 200-i. There is thus a measurable error between the output from the perception system 2 and the output from the fusion unit 3.

The stochastic gradient descent backpropagation algorithm uses this error between the output from the perception system 2 and the output from the fusion unit 3, represented by the loss function, to update the weights of the neural network 50.

The feedback loop between the output from the fusion system 3 and the input of the perception system 2 thus makes it possible to use the error metric to update online the weights of the model represented by the neural network 50, used by the estimation device 100. The error metric is therefore used as input for the learning module 5 for online learning, while the output from the online learning is used to update the perception model represented by the neural network 50. The precision of the estimation device (detection or prediction) is therefore continuously improved compared to the driving assistance systems from the prior art, which perform the learning and the updating of the weights “offline”.

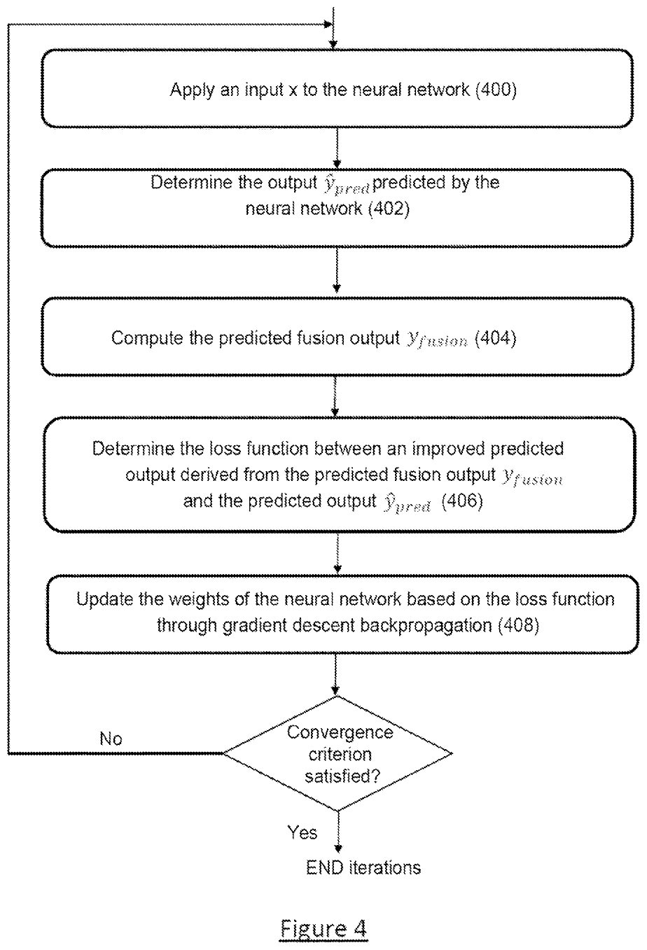

FIG. 4 is a flowchart showing the neural network online learning method, according to some embodiments.

The ML learning-based learning method uses one or more neural networks 50 parameterized by a set of parameters θ (weights of the neural network) and:
The values ŷₖ predicted by the neural network in response to input data, also called “input samples”, denoted x=imageₖ. The outputs or predicted values ŷₖ are defined by: ŷₖ=NeuralNet (imageₖ, θ),
A cost function, also called a loss function L(yₖ, ŷₖ) defining an error between:
an improved predicted value yₖ derived from the output y_{fusion} from the fusion system 3, the fusion output being computed based on predicted outputs ŷₖ delivered by the perception system 2, and
a value ŷₖ predicted by the neural network in response to input data representing images captured by one or more sensors 200.

The (real-time or non-real-time, delayed or non-delayed) fusion system 3 indeed provides a more precise estimation y_{fusion} of the object data ŷₖ that is obtained after applying one or more fusion algorithms implemented by the fusion system 3.

In some embodiments, the improved predicted value yₖ (also denoted \hat{x}_{K|N}) derived from the fusion output y_{fusion} may be obtained by performing a processing operation carried out by the transformation unit 1003, by applying for example a Kalman filter. In one embodiment, the improved predicted value yₖ may be the fusion output y_{fusion} itself.

The learning method furthermore uses:
An approximation of the loss function L(yₖ, ŷₖ),
An update of the weights θ through gradient descent of the network parameters such that:

θ←θ−α∇_{θ}L(yₖ, ŷₖ) where ∇_{θ}L(yₖ, ŷₖ) represents the gradient of the loss function.

More precisely, in step 400, an image x corresponding to one or more detected objects is captured by a sensor 200 of the perception system 2 and is applied to the neural network 50.

In step 402, the response ŷₖ from the neural network 50 to the input x, representing the output predicted by the neural network 50, is determined using the current value of the weights θ according to:

ŷₖ=NeuralNetwork (x, θ)

The output ŷₖ predicted in response to this input x corresponds to a variable estimated by the estimation device 100 in relation to features of objects detected in the environment of the vehicle. For example, in an application to object detection, in which the variable estimated by the estimation device 100 is an object state vector comprising the position data of the detected object and the associated covariance matrix, the predicted output ŷₖ for the image x captured by the sensor 200 represents the state vector predicted by the neural network based on the detected image X.

In step 403, the pair of values including the input x and the obtained predicted output ŷₖ may be stored in memory.

Steps 402 and 403 are reiterated for images x corresponding to captures taken by various sensors 200.

In step 404, when a condition for sending to the fusion system 3 is detected (for example expiry of a given or predefined time), the fusion output y_{fusion}, corresponding to the various predicted values ŷₖ is computed by the perception system 2, thereby providing an improved estimation of the variable in relation to the features of detected objects (for example position data or trajectory data of a target object). The fusion output y_{fusion} is determined by applying at least one fusion algorithm to the various predicted values ŷₖ corresponding to the various sensors 200.

In one embodiment, the samples corresponding to observations accumulated during a predefined time period (for example 5 seconds) may be stored in an experience replay buffer 1002, which may or may not be prioritized. In one embodiment, the samples may be compressed and encoded beforehand by an encoder 1001 (RNN encoder for example) before being stored in the replay buffer 1002.

In step 406, the error between an improved predicted output derived from the fusion outputs yₖ from the fusion system and the output ŷₖ from the perception system 2 is computed.

The improved predicted output yₖ may be an output (denoted \hat{x}_{K|N}) derived from the output from the fusion system by applying a processing operation (Kalman filtering for example implemented by the transformation unit 1003). In one embodiment, the fusion output may be used directly as improved predicted output. This error is represented by a loss function L(yₖ, ŷₖ). The error function may be determined based on the data stored in the buffer 1002 after possible decoding by a decoder 1004 and on the improved predicted output yₖ.

In step 408, the weights of the neural network are updated by applying a stochastic gradient descent backpropagation algorithm in order to determine the gradient of the loss function ∇_{θ}L(yₖ, ŷₖ))

The weights may be updated by replacing each weight 9 with the value θ−α∇_{θ}L(yₖ, ŷₖ):

θ←θ−α∇_{θ}L(yₖ,ŷₖ))

Steps 404 and 408 may be repeated until a convergence condition is detected.

The driving assistance system 10 thus makes it possible to implement online, incremental learning using a neural network parameterized by a set of weights θ that is updated continuously and online.

In one embodiment, the output yₖ predicted by the neural network 50 may be the response from the neural network 50 to an input value corresponding to the previous output from the fusion system 3. In such an embodiment, the improved predicted output ŷₖ is an output computed based on the output from the fusion system (3) after processing, for example through Kalman filtering. In such an embodiment, the error function is determined between the improved predicted output derived from the output from the fusion system and the output from the fusion system.

In one embodiment, the output yₖ predicted by the neural network 50 may be the response from the neural network 50 to an input value corresponding to the real-time captures taken by a sensor 200. In such an embodiment, the improved predicted output ŷₖ may be the output computed based on the output from the fusion system (3) after processing, for example through Kalman filtering, or the fusion output itself. In such an embodiment, the error function is determined between the improved predicted output derived from the output from the fusion system and the output from the perception system.

In one embodiment, the output yₖ predicted by the neural network 50 may be the response from the neural network 50 to an input value corresponding to the previous output from the fusion system 3. In such an embodiment, the improved predicted output ŷₖ is an output computed based on the output from the fusion system (3) after processing, for example through Kalman filtering. In such an embodiment, the error function is determined between the improved predicted output derived from the output from the fusion system and the output from the fusion system.

Those skilled in the art will easily understand that the invention is not limited to a variable estimated by the estimation device 100 of state vector type comprising object positions x, y and a covariance matrix.

For example, in one application of the invention to object detection, the neural network 50 may be for example a YOLO neural network (convolutional neural network loading the image only once before performing the detection).

In such an exemplary embodiment, to detect objects, a bounding box may be predicted around objects of interest by the neural network 50. Each bounding box has an associated vector comprising a set of object features for each object, constituting the variable estimated by the estimation device 100 and comprising for example:
an object probability of presence pc,
coordinates defining the position of the bounding box (bₓ, b_{y}, bₕ, b_{w}) in a Cartesian coordinate system, and
a probability of the object belonging to one or more classes (c₁, c₂, . . . , c_{M}), such as for example a car class, a truck class, a pedestrian class, a motorcycle class, etc.

In one exemplary application of the invention to object detection, the determination of the improved predicted output \hat{x}_{K|N} derived from the predicted fusion output y_{fusion} may use a Kalman filtering technique. Such a filtering processing operation may be implemented by the transformation unit 1003.

The fusion system 3 may thus use Kalman filtering to provide an improved estimation \hat{x}_{k|N} of the object data of yₖ (consolidated detection object data or prediction data).

For k=0 to N, the following equations for a state vector x k at the time k are considered:

xₖ₊₁=Aₖxₖ+uₖ+αₖ (Prediction model with a k representing Gaussian noise)

yₖ=Cₖxₖ+βₖ (Observation model with βₖ representing Gaussian noise)

The state vector is a random variable denoted x_{k|k}, at the time k on the basis of the last measurement processing operation at the time k′, where k′=k or k−1. This random variable is characterized by an estimated mean vector x_{k|k-1} and a covariance matrix of the associated prediction error, denoted Γ_{k|k-1}.

The Kalman filtering step comprises two main steps.

In a first step, called prediction step, a prediction is made, consisting in determining:
The predicted mean: xₖ₊₁=Aₖxₖ+uₖ
The predicted covariance (representing the level of increase in uncertainty): Γ_{k|k+1}=AₖΓ_{k|k}Aₖ^{T}+Γ_{αk}

In a second step, called “correction step”, the values predicted in the prediction step of the Kalman filtering are corrected by determining:
The “innovation” (difference between the measured value and the predicted value) derived from the measurement y k for which the neural network 50 is used as measurement system: \tilde{y}ₖ=yₖ−Cₖ\hat{x}_{k|k-1}
The covariance “innovation”: Sₖ=CₖΓ_{k|k-1}Cₖ^{T}+F_{βk}
The Kalman gain: Kₖ=Γ_{k|k-1}Cₖ^{T}Sₖ⁻¹
The corrected mean: x_{k|k}=x_{k|k-1}+Kₖ\tilde{y}ₖ
The corrected covariance representing the level of decrease in uncertainty:

Γ_{k|k}=(I−KₖCₖ)Γ_{k|k-1}

To be able to use such Kalman filtering, the data produced by the Kalman filter (fusion data) may advantageously be stored for a duration in the replay buffer 1002.

The stored data may be further processed by Kalman smoothing, in order to improve the precision of the Kalman estimations. Such a processing operation is suitable for online learning, with the incremental online learning according to the invention possibly being delayed.

Kalman smoothing comprises implementing the following processing operations for K=0 to N:

Jₖ=Γ_{k|k}Aₖ^{T}Γ_{k+1|k}⁻¹

\hat{x}_{k|N}=\hat{x}_{k|k}+Kₖ(\hat{x}_{k+1|N}−\hat{x}_{k+1|k})

Γ_{k|N}=Γ_{k|k}+Jₖ(Γ_{k+1|N}−γ_{k+1|k})Jₖ^{T}

The smoothing step applied to the sensor fusion outputs stored in the buffer 1002 provides a more precise estimation \hat{x}_{k|N} of the values yₖ predicted by the neural network 50.

In a first exemplary application of the invention to object detection, according to some embodiments, consideration is given for example to a YOLO neural network and 3 classes, for which the variable estimated by the estimation device is given by:

yₖ=[p_{c} bₓ b_{y} bₕ b_{w} c₁ c₂ c₃]^{T}

Consideration is also given to:
The coordinates of a bounding box associated with the loss of location, denoted (xᵢ, yᵢ, wᵢ, hᵢ);
A confidence score c i representing the confidence level of the model according to which the box contains the object;
Conditional class probabilities represented by Pr(Classᵢ|Object).

The loss function L(yₖ,ŷₖ) may for example be defined based on the parameters xᵢ, yᵢ, wᵢ, hᵢ, cᵢ and Pr(Classᵢ|Object).

In such a first example, the learning method implements steps 402 to 408 as described below:

In step 402, the neural network 50 predicts the output:

ŷₖ=NeuralNetwork (x, θ)
In step 404, the predicted value yₖ is set to the corresponding fusion value \hat{x}_{k|N} determined by the fusion system 2.
In step 406, the loss function L(yₖ=\hat{x}_{k|N}, ŷₖ) is computed for each detected object (for example for each bounding box in the example of the YOLO neural network) using for example a non-maximum suppression algorithm.
In step 408, the step of updating the weights of the neural network is implemented for each detected object (for each bounding box in the example of the YOLO neural network) by using a gradient descent algorithm, each weight θ being updated to the value θ−α∇_{θ}L(\hat{x}_{k|N}, ŷₖ).

The weights θ updated in step 404 may be adjusted such that the new prediction of the neural network 50 is as close as possible to the improved estimation \hat{x}_{k|N} of yₖ.

In a second exemplary application, the estimation method may be applied to trajectory prediction.

Hereinafter, the notation y⁽ⁱ⁾ will be used to represent the predicted trajectory vector:

$${y}^{( i )} = [ {[ \begin{matrix}x \\ y\end{matrix} ]}_{1} … … . {[ \begin{matrix}c \\ y\end{matrix} ]}_{{T}_{y}} ]$$

Moreover, the notation ŷ⁽ⁱ⁾ will be used to represent the fusion trajectory vector:

$${\hat{y}}^{( i )} = [ {[ \begin{matrix}{μ}_{x} \\ {μ}_{y} \\ {σ}_{x} \\ {σ}_{y} \\ ρ\end{matrix} ]}_{1} … … . {[ \begin{matrix}{μ}_{x} \\ {μ}_{y} \\ {σ}_{x} \\ {σ}_{y} \\ ρ\end{matrix} ]}_{{T}_{y}} ]$$

In this second example, it is considered that the perception system 2 does not use a memory 1002 of replay buffer 1002 type to store the data used to determine the loss function.

Moreover, to guarantee that the fusion data are “iid” data, a random time counter may be used, its value being set after each update of the weights.

When the value set for the time counter has expired, a new update of the weights may be performed iteratively.

The loss function L or loss function may be any type of loss function including a squared error function, a negative log likelihood function, etc.

In the second example under consideration, it is assumed that the loss function Lₙᵢᵢ is used, applied to a bivariate Gaussian distribution. However, those skilled in the art will easily understand that any other loss function may be used. The function Lₙᵢᵢ is defined by:

$$L = log ( {σ}_{x} {σ}_{y} \sqrt{1 - {ρ}^{2}} ) + \frac{0}{1 - {ρ}^{2}} [ \frac{{( x - {μ}_{x} )}^{2}}{{σ}_{x}^{2}} + \frac{{( y - {μ}_{y} )}^{2}}{{σ}_{y}^{2}} - \frac{2 ρ ( x - {μ}_{x} ) ( y - {μ}_{y} )}{{σ}_{x} {σ}_{y}} ]$$

The online learning method, in such a second example, implements the steps of FIG. 4 as follows:
In step 400, a trajectory vector x⁽ⁱ⁾, corresponding to the capture of a sensor 200 of the perception system 2, is applied at input of the neural network 50.
In step 402, the predicted trajectory ŷ⁽ⁱ⁾ is determined over T seconds based on the trajectory vector x⁽ⁱ⁾ applied at input of the neural network and the current weights θ of the neural network:

ŷ⁽ⁱ⁾=NeuralNet(x⁽ⁱ⁾,θ)
In step 403, the pair (ŷ⁽ⁱ⁾,x⁽ⁱ⁾) comprising the predicted trajectory ŷ⁽ⁱ⁾=ŷ_{perception}⁽ⁱ⁾ and the input trajectory vector x⁽ⁱ⁾) are saved in a memory 1002.
The method is put on hold until T seconds have elapsed (timer).
In step 404, the fusion trajectory vector y_{fusion} is determined.
In step 406, the loss function is computed, representing the error between the output from the fusion system and the output from the perception system 2.
In step 408, the value of the weights θ is set to θ−α∇_{θ}L(y_{fusion},ŷ_{perception}⁽ⁱ⁾).
The saved pair may then be deleted and a new value may be set for the time counter.

The above steps may be reiterated until a convergence condition is satisfied.

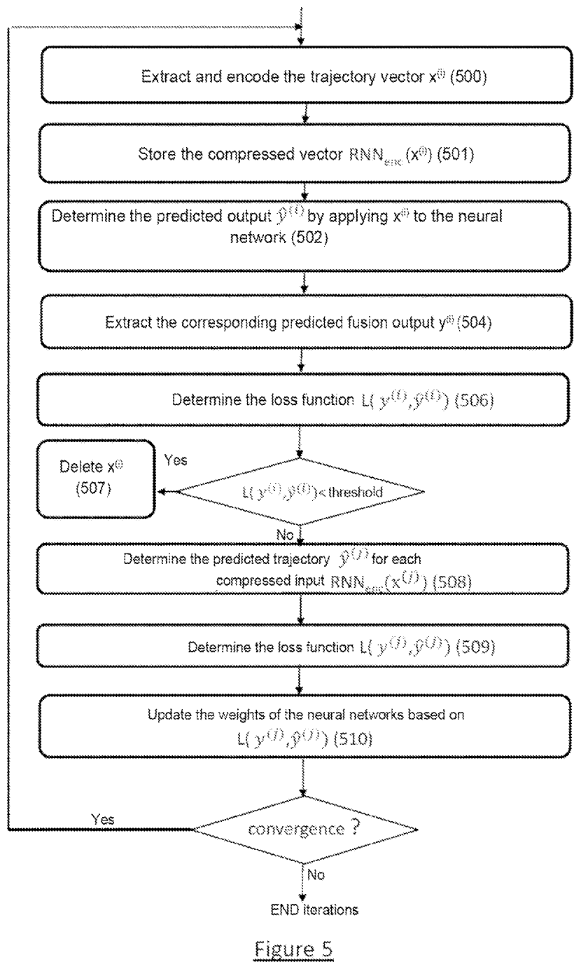

FIG. 5 is a flowchart showing the learning method according to a third example in one application of the invention to trajectory prediction (the variable estimated by the method for estimating a variable in relation to a detected object comprises object trajectory parameters).

In such an exemplary embodiment, the online learning method uses a prioritized experience replay buffer 1002.

In this embodiment, for each trajectory prediction, an associated prediction loss is computed online using the output from the delayed or non-delayed fusion system.

The ground truth corresponding to the predicted value may be approximated by performing updates to the output from the (delayed or non-delayed) fusion system.

The loss function may be computed between an improved predicted output

derived from the (delayed or non-delayed) fusion output y_{fusion} and the trajectory predicted by the neural network ŷ_{pred}⁽ⁱ⁾ for each sensor under consideration. Depending on a threshold value, it may furthermore be determined whether or not an input x⁽ⁱ⁾ is useful for online learning. If it is determined as being useful for learning, a compact representation of the trajectory associated with this input, for example determined by way of an RNN encoder 1001, may be stored in the replay buffer 1002 (experience replay buffer).

Such an embodiment makes it possible to optimize and prioritize the experience corresponding to the inputs used to supply the learning table 12. Moreover, the data stored in the replay buffer 1002 may be sampled randomly in order to guarantee that the data are “iid” (by the transformation unit 1003). This embodiment makes it possible to optimize the samples used and to reuse the samples.

The use of the RNN encoder makes it possible to optimize the replay buffer 1002 by compressing the trajectory information.

In the example of FIG. 5, the loss function Lₙᵢᵢ is also used by way of non-limiting example.

In step 500, the history of the trajectory vector x⁽ⁱ⁾ is extracted and is encoded by the RNN encoder 1001, thereby providing a compressed vector RNN_{enc}(x⁽ⁱ⁾).

In step 501, the compressed vector RNN_{enc}(x⁽ⁱ⁾) (encoded sample) is stored in the replay buffer 1002.

In step 502, the predicted trajectory ŷ⁽ⁱ⁾ is determined based on the trajectory vector x⁽ⁱ⁾ applied at input of the neural network 50 and the current weights θ of the neural network, with ŷ⁽ⁱ⁾=ŷ_{pred}⁽ⁱ⁾:

ŷ⁽ⁱ⁾=NeuralNet(x⁽ⁱ⁾,θ)

In step 504, the fusion trajectory vector y⁽ⁱ⁾ determined beforehand by the fusion system is extracted (embodiment with delay).

In step 506, the loss function is computed based on the fusion output y⁽ⁱ⁾ and the predicted values ŷ_{pred}⁽ⁱ⁾ corresponding to the perception output, and the current weights θ of the network: L(y⁽ⁱ⁾, ŷ_{pred}⁽ⁱ⁾), in an embodiment with delay.

In step 507, if the loss function L(y⁽ⁱ⁾,ŷ_{pred}⁽ⁱ⁾) is small compared to a threshold, the sample value x⁽ⁱ⁾ is deleted from the buffer 1002 (not useful).

In step 508, for each compressed sample RNN_{enc}(x^{(j)}) of the buffer 1002, the predicted trajectory ŷ^{(j)} is determined based on the compressed trajectory vector RNN_{enc}(x^{(j)}) and the current weights θ of the neural network:

ŷ^{(j)}=NeuralNet(RNN_{enc}(x^{(j)}),θ)

In step 509, the loss function is computed again based on the predicted value ŷ^{(j)} provided at output of the neural network 50, the corresponding improved predicted output value (fusion output y^{(j)}) and the current weights θ of the network: L(y^{(j)},ŷ^{(j)}).

In step 510, the value of the weights θ is set to θ−α∇_{θ}L(y^{(j)},ŷ_{pred}^{(j)}).

The above steps may be iterated until a convergence condition is detected.

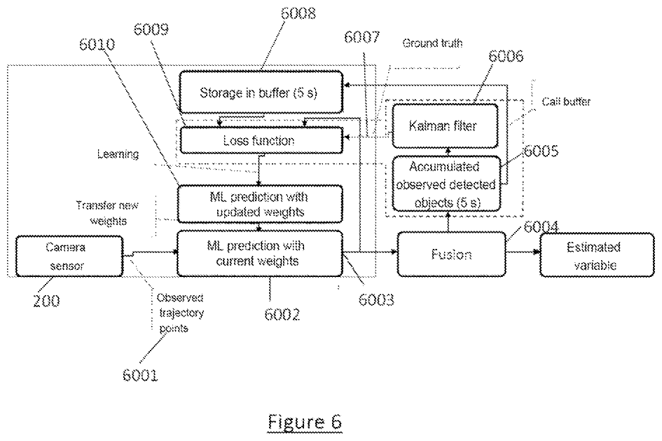

FIG. 6 shows one exemplary implementation of the control system 10 in which the perception system 2 uses a single smart camera sensor 200 for one application of the invention to object trajectory prediction.

In this example, the camera sensor (200) observes trajectory points of a target object detected in the environment of the vehicle (6001). The data captured by the sensor 200 are used to predict a trajectory of the target object with the current weights (6002) using the machine learning unit 5 based on the neural network 50.

The neural network 50 provides a predicted output (6003) representing the trajectory predicted by the neural network 50 based on the data from the sensor 200 applied at input of the neural network 50.

The predicted output is transmitted to the fusion system (3), which computes an improved predicted output (6004) corresponding to the variable estimated by the estimation device 100. In this example, the variable represents the predicted trajectory of the target object and comprises trajectory parameters.

The estimation device provides the predicted trajectory to the driving assistance system 10 for use by a control application 14.

Moreover, the fusion system 3 transmits the improved predicted output to the error computation unit 4. The error computation unit may store (6008) the predicted outputs (perception outputs) in a buffer 1002 in which the outputs corresponding to observations (6005) are accumulated over a predefined time period (for example 5 s).

The transformation unit 1003 may apply additional processing operations in order to further improve the precision of the improved predicted outputs, for example by applying a Kalman filter (6006) as described above, thereby providing a refined predicted output (6007). The error computation unit 4 then determines the loss function (6009) representing the error between the output from the perception system 2 and the refined predicted output using the data stored in the buffer 1002 and the refined predicted output. The weights are then updated by applying a gradient descent backpropagation algorithm using the loss function between the refined predicted output (delivered at the output of the Kalman filter 6006) and the output from the perception system and a new ML prediction (6010) may be implemented by the online learning module 50 using the neural network 50 with the weights updated in this way.

In the example of FIG. 6, the output from the fusion system 3 is used as ground truth for learning.

In the embodiment of FIG. 6, the loss function corresponds to the error between the refined predicted output 6007 determined by the transformation module 1003 and the perception output 2 delivered by the perception system.

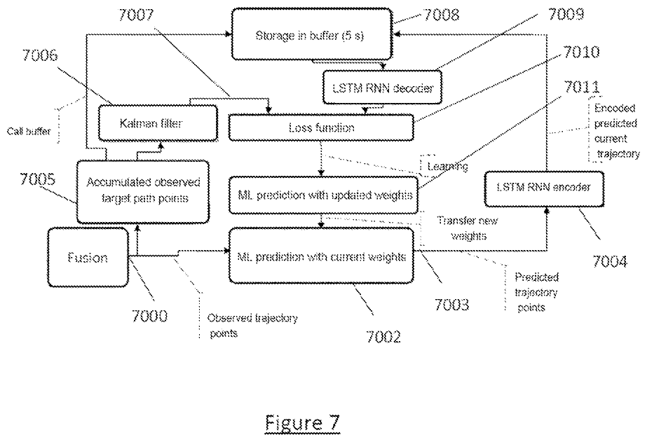

FIG. 7 shows another exemplary embodiment of the control system 10 using RNN encoding/decoding of the data predicted by the neural network 50. In this example, the variable represents the predicted trajectory of a target object and comprises trajectory parameters. Moreover, the output from the fusion system is used as ground truth (input applied to the neural network 50 for online learning).

In the embodiment of FIG. 7, the output from the fusion system 3 is used directly as input applied to the neural network to determine the loss function. The loss function then corresponds to the error between the output from the fusion system 3 and the refined predicted output delivered by the transformation unit 3.

In the embodiment of FIG. 7, the fusion output (improved predicted output) delivered by the fusion system 3 is applied at input of the neural network 50 (7000) to predict a trajectory of a target object with the current weights (7002) using the machine learning unit 5 based on the neural network 50.

The neural network 50 provides a predicted output (7003) representing the trajectory predicted by the neural network 50 based on the data from the sensor 200 applied at input of the neural network 50.

The predicted output is transmitted to an RNN encoder 1001, which encodes and compresses the output predicted by the neural network 50 (7004).

Moreover, the fusion system 3 transmits the improved predicted output to the error computation unit 4. The error computation unit may store (7008) the predicted outputs in a buffer 1002 in which the perception outputs corresponding to observations (7005) are accumulated over a predefined time period (for example 5 s).

The transformation unit 1003 may apply additional processing operations in order to further improve the precision of the improved predicted outputs, for example by applying a Kalman filter (7006) as described above, thereby providing a refined predicted output (7007). The error computation unit 4 then determines the loss function (7010) representing the error between the output from the perception system 2 and the refined predicted output using the data stored in the buffer 1002, after decoding by an RNN decoder (7009), and the refined predicted output 7007. The weights are then updated by applying a gradient descent backpropagation algorithm using the loss function between the refined predicted output (delivered at the output of the Kalman filter 6006) and the output from the perception system and a new ML prediction (7011) may be implemented by the online learning unit 5 using the neural network 50 with the weights updated in this way.

One variant of the embodiment of FIG. 7 may be implemented without using an RNN encoder/decoder (blocks 7004 and 7009). In such a variant, the output 7003 is stored directly in the buffer (block 7008) and the loss function is determined using the data from the buffer 1002 directly, without RNN decoding (block 7009).

The embodiments of the invention thus allow an improved estimation of a variable in relation to an object detected in the environment of the vehicle by implementing online learning.

The learning according to the embodiments of the invention makes it possible to take into account new images collected in real time during operation of the vehicle and is not limited to the use of learning data stored in the database offline. New estimations may be made during operation of the driving assistance system, using weights of the neural network that are updated online.

Those skilled in the art will furthermore understand that the system or subsystems according to the embodiments of the invention may be implemented in various ways by way of hardware, software, or a combination of hardware and software, in particular in the form of program code able to be distributed in the form of a program product, in various forms. In particular, the program code may be distributed using computer-readable media, which may include computer-readable storage media and communication media. The methods described in this description may in particular be implemented in the form of computer program instructions able to be executed by one or more processors in a computing device. These computer program instructions may also be stored in a computer-readable medium.

Moreover, the invention is not limited to the embodiments described above by way of non-limiting example. It encompasses all variant embodiments that might be envisaged by those skilled in the art.

In particular, those skilled in the art will understand that the invention is not limited to particular types of sensors of the perception system 2 or to a particular number of sensors.

The invention is not limited to any particular type of vehicle 1 and applies to any type of vehicle (examples of vehicles include, without limitation, cars, trucks, buses, etc.). Although they are not limited to such applications, the embodiments of the invention are particularly advantageous for implementation in autonomous vehicles connected by communication networks allowing them to exchange V2X messages.

The invention is also not limited to any type of object detected in the environment of the vehicle and applies to any object able to be detected by way of sensors 200 of the perception system 2 (pedestrian, truck, motorcycle, etc.).

Moreover, those skilled in the art will easily understand that the concept of “environment of the vehicle” used in relation to object detection is defined in relation to the range of the sensors implemented in the vehicle.

The invention is not limited to the variables estimated by the estimation device 100, described above by way of non-limiting example. It applies to any variable in relation to an object detected in the environment of the vehicle, possibly including variables in relation to the position of the object and/or the movement of the object (speed, trajectory, etc.) and/or object features (type of object, etc.). The variable may have various formats. When the estimated variable is a state vector comprising a set of parameters, the number of parameters may depend on the application of the invention and on the specific features of the driving assistance system.

The invention is also not limited to the example of a YOLO neural network cited by way of example in the description and applies to any type of neural network used for estimating variables in relation to objects detected or able to be detected in the environment of the vehicle, based on machine learning.

Those skilled in the art will easily understand that the invention is not limited to the exemplary loss functions cited in the description above by way of example.

1-11. (canceled)

12. A control device implemented in a vehicle, the vehicle comprising a perception system using a set of sensors, each sensor providing data, the perception system comprising an estimation device configured to estimate a variable comprising at least one feature in relation to one or more objects detected in an environment of the vehicle, the estimation device comprising an online learning module using a neural network to estimate said variable, the neural network being associated with a set of weights, the learning module comprising:
a forward propagation module configured to propagate data from one or more sensors applied at an input of the neural network, so as to provide a predicted output comprising an estimation of said variable;
a fusion system configured to determine a fusion output by implementing at least one sensor fusion algorithm based on at least some of said predicted values; and
a backpropagation module configured to update the weights associated with the neural network online by determining a loss function representing an error between an improved predicted value of said fusion output and said predicted output by performing a gradient descent backpropagation.

13. The device as claimed in claim 12, wherein said variable is a state vector comprising information in relation to the position and/or the movement of an object detected by the perception system.

14. The device as claimed in claim 13, wherein said state vector further comprises information in relation to one or more detected objects.

15. The device as claimed in claim 14, wherein said state vector further comprises trajectory parameters of a target object.

16. The device as claimed in claim 12, wherein said improved predicted value is determined by applying a Kalman filter.

17. The device as claimed in claim 12, further comprising a replay buffer configured to store the outputs predicted by the estimation device and/or the fusion outputs delivered by the fusion system.

18. The device as claimed in claim 17, further comprising a recurrent neural network encoder configured to encode and compress the data prior to storage in the replay buffer, and a decoder configured to decode and decompress the data extracted from the replay buffer.

19. The device as claimed in claim 18, wherein the encoder is a recurrent neural network encoder and the decoder is a recurrent neural network decoder.

20. The device as claimed in claim 17, wherein the replay buffer is prioritized.

21. The device as claimed in claim 17, wherein the device is configured to implement a condition for testing input data applied at input of a neural network, input data being deleted from the replay buffer when the loss function between the value predicted for this input sample and the fusion output is lower than a predefined threshold.

22. A control method implemented in a vehicle, the vehicle comprising a perception system using a set of sensors, each sensor providing data, the control method comprising:
estimating a variable comprising at least one feature in relation to one or more objects detected in an environment of the vehicle, wherein the estimating implements online learning step a neural network to estimate said variable, the neural network being associated with a set of weights,
wherein the online learning comprises:
propagating data from one or more sensors, applied at an input of the neural network, so as to provide a predicted output comprising an estimation of said variable;
determining a fusion output by implementing at least one sensor fusion algorithm based on at least some of said predicted values; and
updating the weights associated with the neural network online by determining a loss function representing an error between an improved predicted value of said fusion output and said predicted output by performing a gradient descent backpropagation.
